(19) United States
(12) Patent Application Publication
(10) Pub. No.: US 2026/0357115 A1
(43) Pub. Date: Nov. 12, 2026

(54) TWO-PART ADHESIVE COMPOSITION AND METHOD OF MAKING A BONDED ARTICLE

(71) Applicant: 3M INNOVATIVE PROPERTIES COMPANY, St. Paul, MN (US)

(72) Inventor: Nelson T. Rotto, Woodbury, MN (US)

(21) Appl. No.: 19/475,268

(22) PCT Filed: Apr. 12, 2024
(86) PCT No.: PCT/IB2024/053621

§ 371 Date: Oct. 14, 2025

Related U.S. Application Data
(60) Provisional application No. 63/459,518, filed on Apr. 14, 2023.

(51) Int. Cl. C09J 133/12; C09J 103/02

(52) U.S. Cl. CPC C09J 133/12; C09J 103/02

(57) ABSTRACT

A two-part adhesive composition includes a first part and a second part. The first part includes methyl methacrylate; a block copolymer of a block copolymer of methyl methacrylate and at least one of a C₄-C₉ alkyl acrylate or methacrylate or a C₂₋₄ hydroxyalkyl acrylate or methacrylate; a free-radical initiator comprising at least one of a peroxide initiator or a hydroperoxide initiator; and a free-radical inhibitor. The second part includes methyl methacrylate; a crosslinker having two or more acrylate groups, methacrylate groups, or a combination thereof; an acrylic monomer comprising at least one of a phosphate or phosphonate group; and vanadyl acetylacetonate. A method of making a bonded article using the two-part adhesive composition is also described.

### CROSS-REFERENCE TO RELATED APPLICATION

This application claims priority to U.S. Provisional Application No. 63/459,518, filed Apr. 14, 2023, the disclosure of which is incorporated by reference in its entirety herein.

### BACKGROUND

Adhesives are known to be useful for bonding one substrate to another, e.g., a metal to a metal, a metal to a plastic, a plastic to a plastic, a glass to a glass. Structural adhesives are attractive alternatives to mechanical joining methods, such as riveting or spot welding, because structural adhesives distribute load stresses over larger areas rather than concentrating such stresses at a few points. Structural adhesives may also produce cleaner and quieter products because they can dampen vibration and reduce noise. Additionally, structural adhesives can be used to bond a variety of materials, sometimes without extensive surface preparation.

Certain curable acrylic adhesive compositions are disclosed in U.S. Pat. No. 5,206,288 (Gosiewski), U.S. Pat. No. 5,863,989 (Taguchi), U.S. Pat. No. 6,852,801 (Briggs), U.S. Pat. No. 8,067,500 (Hisha), U.S. Pat. No. 10,392,532 (Doe), and U.S. Pat. No. 11,098,225 (Sasaki), U.S. Pat. Appl. Pub. No. 2019/0136102 (Hurlburt), Int. Pat. Appl. Pub. No. WO2021/051257 (Sun), European Pat. Appl. Pub. No. 4130179 (published Feb. 8, 2023), and Japanese Pat. Appl. Pub. Nos. 2014088458 (published May 15, 2014) and 2003/165806 (published Jun. 10, 2003.)

### SUMMARY

The present disclosure provides a composition useful, for example, as a sealant or adhesive, for example, a structural adhesive.

In one aspect, the present disclosure provides a two-part adhesive composition having a first part and a second part. The first part includes methyl methacrylate; a block copolymer of methyl methacrylate and at least one of a C₄-C₉ alkyl acrylate or methacrylate or a C₂₋₄ hydroxyalkyl acrylate or methacrylate; a free-radical initiator comprising at least one of a peroxide initiator or a hydroperoxide initiator; and a free-radical inhibitor. The second part includes methyl methacrylate; a crosslinker having two or more acrylate groups, methacrylate groups, or a combination thereof; an acrylic monomer comprising at least one of a phosphate or phosphonate group; and vanadyl acetylacetonate.

In another aspect, the present disclosure provides a two-part adhesive composition including a first part comprising methyl methacrylate; a poly(methyl methacrylate)-poly(n-butyl (meth)acrylate)-poly(methyl methacrylate) triblock copolymer; cumene hydroperoxide; a free-radical inhibitor; corn starch; and fumed silica, and a second part comprising methyl methacrylate; methacrylic acid; a crosslinker having two or more acrylate groups, methacrylate groups, or a combination thereof; an acrylic monomer comprising at least one of a phosphate or phosphonate group; at least one elastomer; a free-radical inhibitor; vanadyl acetylacetonate; a wax; and a pigment.

In another aspect, the present disclosure provides a first part of a two-part adhesive composition. The first part includes methyl methacrylate, a block copolymer of methyl methacrylate and at least one of a C₄-C₉ alkyl acrylate or methacrylate or a C₂₋₄ hydroxyalkyl acrylate or methacrylate, a free-radical initiator comprising at least one of a peroxide initiator or a hydroperoxide initiator, a free-radical inhibitor, and starch.

In another aspect, the present disclosure provides a second part of a two-part adhesive composition. The second part includes monomers and vanadyl acetylacetonate, wherein the monomers consist of methyl methacrylate; a non-cyclic crosslinker having two or more acrylate groups, methacrylate groups, or a combination thereof; an acrylic monomer comprising at least one of a phosphate or phosphonate group; methacrylic acid; and combinations thereof.

In another aspect, the present disclosure provides a method of making a bonded article. The method includes combining the first part and the second part of the two-part adhesive composition disclosed herein with a free-radical initiator to provide an adhesive, applying the adhesive on at least one of the first substrate or the second substrate, adhering the first substrate and the second substrate using the adhesive, allowing the adhesive to at least partially cure to make the bonded article.

In another aspect, the present disclosure provides an article bonded with the two-part composition disclosed herein and/or made by the method disclosed herein.

As used herein:
“alkyl group” and the prefix “alk-” have only C—C bonds and C—H bonds and are inclusive of both straight chain and branched chain groups and of cyclic groups. In some embodiments, alkyl groups have up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms and other alkyl substituents;
“Aryl” and “aromatic” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups, examples of which include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl;
the term “acrylic” refers to both acrylic and methacrylic polymers, oligomers, and monomers;
“cure” refers to making polymer chains from one or more monomers; and
the term “(meth)acryl” refers to acryl (also referred to in the art as acryloyl and acrylyl) and/or methacryl (also referred to in the art as methacryloyl and methacrylyl).

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

Herein, the term “comprises” and variations thereof do not have a limiting meaning where these terms appear in the description and claims. Such terms will be understood to imply the inclusion of a stated element or group of elements but not the exclusion of any other element or group of elements. By “consisting of” is meant including and limited to whatever follows the phrase “consisting of.” Thus, the phrase “consisting of” indicates that the listed elements are required or mandatory, and that no other elements may be present. Any of the elements or combinations of elements that are recited in this specification in open-ended language (e.g., comprise and derivatives thereof), are considered to additionally be recited in closed-ended language (e.g., consist and derivatives thereof).

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent. The term “crosslinked” includes partially crosslinked.

“Open time” can be understood as the amount of time before an adhesive becomes too cured to bond well to a substrate. More specifically, open time is defined as the time the mixed adhesive can be left unbonded and still achieve 80% or more of the overlap shear strength that can be achieved when the adhesive is mixed and immediately bonded between two adherends.

All numerical ranges are inclusive of their endpoints and non-integral values between the endpoints unless otherwise stated (e.g., 1 to 5 includes 1, 1.5, 2, 2.75, 3, 3.80, 4, 5, etc.).

Features and advantages of the present disclosure will be further understood upon consideration of the detailed description as well as the appended claims.

### BRIEF DESCRIPTION OF THE FIGURES

The drawings illustrate generally, by way of example, but not by way of limitation, various embodiments discussed in the present disclosure.

FIG. 1 is graphical representation of the storage modulus vs. time curves for Examples M-2, M-3, M-4, M-6, M-8, and M-9, and Illustrative Example M-1.

### DETAILED DESCRIPTION

The present disclosure provides a two-part adhesive composition. The first part and the second part include methyl methacrylate. In some embodiments, the first part includes 25 weight percent (wt. %) to 65 wt. %, 35 wt. % to 55 wt. %, or 40 wt. % to 50 wt. % methyl methacrylate, based on the total weight of the first part of the two-part adhesive composition. In some embodiments, the second part includes 20 wt. % to 60 wt. %, 25 wt. % to 50 wt. %, or 30 wt. % to 45 wt. % methyl methacrylate, based on the total weight of the second part of the two-part adhesive composition. Methyl methacrylate is commercially available from a variety of suppliers, including from Evonik Performance Materials GmbH under the trade designation “VISIOMER MMA”.

The first part of the two-part adhesive composition of the present disclosure includes a free-radical initiator comprising at least one of a peroxide initiator or a hydroperoxide initiator. Examples of free-radical initiators useful for practicing the present disclosure include cumene hydroperoxide, paramenthane hydroperoxide, tert-butyl hydroperoxide, tert-amyl hydroperoxide, diisopropylbenzene dihydroperoxide, methyl ethyl ketone peroxide, benzoyl peroxide, t-butyl peroxyacetate, and tert-butyl peroxybenzoate. In some embodiments, the free-radical initiator is present in an amount from 0.1 wt. % to 3.5 wt. %, 0.5 wt. % to 3.5 wt. %, or 1 wt. % to 3 wt. %, based on the total weight of the first part.

In some embodiments, the two-part adhesive composition is free of acid chloride or comprises not more than 0.05 weight percent of an acid chloride, based on the total weight of the two-part adhesive composition. In some embodiments, the first part of the two-part adhesive composition is free of acid chloride or comprises not more than 0.05 weight percent of an acid chloride, based on the total weight of the first part. Acid chlorides are reported as required co-agent initiators in U.S. Pat. No. 10,392,532 (Doe). Examples of acid chlorides include sulfonyl chlorides such as p-toluene sulfonyl chloride, p-methoxy benzene sulfonyl chloride, 4,4′-oxybis(benzene sulfonyl chloride), and diacid chlorides.

The second part of the two-part adhesive composition of the present disclosure includes vanadyl acetylacetonate. Vanadyl acetylacetonate is also known as “vanadium (IV) oxide bis(2,4-pentanedionate)”, “vanadium (IV)-oxy acetylacetonate”, and VO(acac)₂. In some embodiments, the vanadyl acetylacetonate is present in an amount from 0.05 wt. % to 2 wt. %, 0.25 wt. % to 1.5 wt. %, or 0.5 wt. % to 1 wt. %, based on the total weight of the second part. When the first part and the second part of the two-part adhesive composition are combined, vanadium reduces the hydroperoxide or peroxide and is oxidized from vanadium+4 to vanadium+5.

In some embodiments, the second part is essentially free of other reducing agents and/or accelerants. In some embodiments, the second part is essentially free of thioureas (e.g., pyridyl thiourea), amines (e.g., primary amines, secondary amines, tertiary amines, pyridines such as 3,5-diethyl-1,2-dihydro-1-phenyl-2-propylpyridine, hydroxyethyl toluidine, N,N-dimethyl-4-toluidine, imidazoles, and quinolines), aldehyde-amine condensates, and other metal salt reducing agents (e.g., cobalt acetylacetonate, copper acetylacetonate, copper phthalocyanine, zinc acetylacetonate, iron acetylacetonate, titanium acetylacetonate, vanadium (III) acetylacetonate, vanadium (III) pentanedionate, vanadium (III) naphthenate, vanadium (IV) naphthenate, copper naphthenate, and copper salicylate). “Essentially free of” in this context refers to an amount less than 0.05 wt. %, 0.01 wt. %, 0.005 wt. %, or 0.001 wt. % and includes 0 wt. %, based on the total weight of the second part.

The first part of the two-part adhesive composition of the present disclosure includes a free-radical inhibitor. In some embodiments, the second part of the two-part adhesive composition of the present disclosure includes a free-radical inhibitor. Examples of suitable free-radical inhibitors include benzoquinones, naphthoquinone, butylated hydroxytoluene (BHT), hydroquinone, p-methoxy hydroquinone (MEHQ), and combinations thereof. In some embodiments, the free-radical inhibitor is present in an amount from 0.05 wt. % to 2.0 wt. %, 0.25 wt. % to 2.0 wt. %, or 0.5 wt. % to 1.5 wt. %, based on the total weight of the first part. In some embodiments, the free-radical inhibitor is present in the first part in an amount that is at least half of the amount by weight of the free-radical initiator. In some embodiments, the free-radical inhibitor is present in the second part in an amount from 0.05 wt. % to 1.0 wt. %, 0.1 wt. % to 0.5 wt. %, or 0.05 wt. % to 0.25 wt. %, based on the total weight of the second part. Higher amounts of the free-radical inhibitor are typically useful to prevent gelation in the first part, which includes a peroxide or hydroperoxide, than in the second part.

The first part of the two-part adhesive composition of the present disclosure includes a block copolymer. The block copolymer contains hard segments and soft segments. The soft segments and uncrystallized hard segments form an amorphous phase, and a portion of the hard segment crystallizes to form crystalline microdomains, which can function as physical crosslinking domains. Such block copolymers are typically known as thermoplastic elastomers. The block copolymer in the first part is an acrylic copolymer, in some embodiments, including poly(methyl methacrylate) (PMMA) hard segments. The soft segments of the block copolymer can be formed from monomers of an acrylate or methacrylate having a C₄-C₉ alkyl sidechain or mixtures thereof, for example. Examples of monomers useful for forming the second block include n-butyl methacrylate, n-pentyl methacrylate, n-hexyl methacrylate, n-heptyl methacrylate, 2-ethylhexyl methacrylate, isooctyl methacrylate, n-octyl methacrylate, n-nonyl methacrylate, acrylates of the foregoing methacrylates, and mixtures thereof. In some embodiments, monomers useful for forming soft segments include a C₂₋₄ hydroxyalkyl acrylate or methacrylate such as 2-hydroxyethyl acrylate, 3-hydroxypropyl acrylate, 2-hydroxyethyl methacrylate, and 3-hydroxypropyl methacrylate.

In some embodiments, the block copolymer is a triblock copolymer of methyl methacrylate/C₄-C₉ alkyl acrylate or methacrylate/methyl methacrylate. In some embodiments, the block copolymer is made from PMMA and poly(butyl acrylate) or poly(butyl methacrylate) and is a poly(methyl methacrylate)-poly(n-butyl(meth)acrylate)-poly(methyl methacrylate) triblock copolymer. In some embodiments, the block copolymer contains about 70% PMMA and 30% poly(n-butyl acrylate). The block copolymer may have a number average molecular weight of up to about 120,000 grams per mole. Suitable commercially available materials useful for the block copolymer include those obtained under the trade designation “ABC KURARITY LA2330” from Kuraray, Chiyoda City, Japan, and those obtained under the trade designation “NANOSTRENGTH” from Arkema, King of Prussia, Pa.

In some embodiments, the first part includes 20 weight percent (wt. %) to 60 wt. %, 25 wt. % to 50 wt. %, or 30 wt. % to 45 wt. % of the block copolymer, including any of those defined above in any of their embodiments, based on the total weight of the first part of the two-part adhesive composition.

In some embodiments, the second part of the two-part adhesive composition includes a block copolymer as defined above in any of their embodiments. However, the second part may include in addition or alternatively other elastomers (e.g., acrylic core/shell polymers; styrene-butadiene/methacrylate core/shell polymers; and acrylonitrile-butadiene rubber). As shown in the Examples, below, other elastomers that are suitable for the second part are not suitable for the first part since they led to gelation of the first part after it was exposed to a temperature of 120 °F (49 °C).

A variety of elastomers may be suitable for the second part as long as the elastomer is a polymeric material having rubber elasticity at room temperature. Examples of elastomers suitable for the second part include various synthetic rubbers such as an acrylic copolymer as described above, a methyl methacrylate-butadiene-styrene copolymer (MBS), an acrylonitrile-styrene-butadiene copolymer, a linear polyurethane, acrylonitrile-butadiene rubber, a styrene-butadiene rubber, a styrene-butadiene-styrene rubber, a polystyrene/EPDM (an ethylene/propylene/conjugated diene copolymer), a chloroprene rubber, a butadiene rubber, and natural rubber. The elastomer useful in the second part may be a core-shell graft copolymers having a “rubbery” core and a “hard” shell. Examples of useful core-shell graft copolymers are those where “hard” monomers, such as styrene, acrylonitrile, or methyl methacrylate, are grafted onto a rubbery core made from polymers of “soft” or “elastomeric” monomers, such as butadiene or ethyl acrylate. The amount of the elastomer present in the second part may be 5 wt. % to 35 wt. %, 10 wt. % to 35 wt. %, or 15 wt. % to 30 wt. %, based on the total weight of the second part.

The second part of the two-part adhesive composition of the present disclosure further includes an acrylic monomer comprising a phosphate or phosphonate group. Useful acrylic monomer comprising a phosphate or phosphonate group include ethylene glycol methacrylate phosphate (available, for example, from Miwon North America, Exton, Pennsylvania, under the trade designations “MIRAMER SC1400” and “MIRAMER SC1400A” and from Allnex, Alpharetta, GA, under the trade designation “EBACRYL 168”) and phosphate esters of poly(propylene glycol) monomethacrylate (available, for example, under the trade designation “SIPOMER PAM” from Solvay Novecare, Cranbury, NJ). Vinyl phosphonic acid may also be useful. In some embodiments, the second part of the two-part adhesive composition of the present disclosure further comprises an acrylic monomer comprising a phosphate group. The phosphonate- or phosphate-functionalized acrylic monomer can be present in the second part, for example, up to 5 wt. %, 4 wt. %, or 3 wt. %, based on the total weight of the second part. In some embodiments, the phosphonate- or phosphate-functionalized acrylic monomer is present in an amount of at least 0.5 wt. %, 1 wt. %, 1.5 wt. %, or 1.9 wt. %, based on the total weight of the second part. Such monomers can be useful, for example, for enhancing the adhesion to metal substrates.

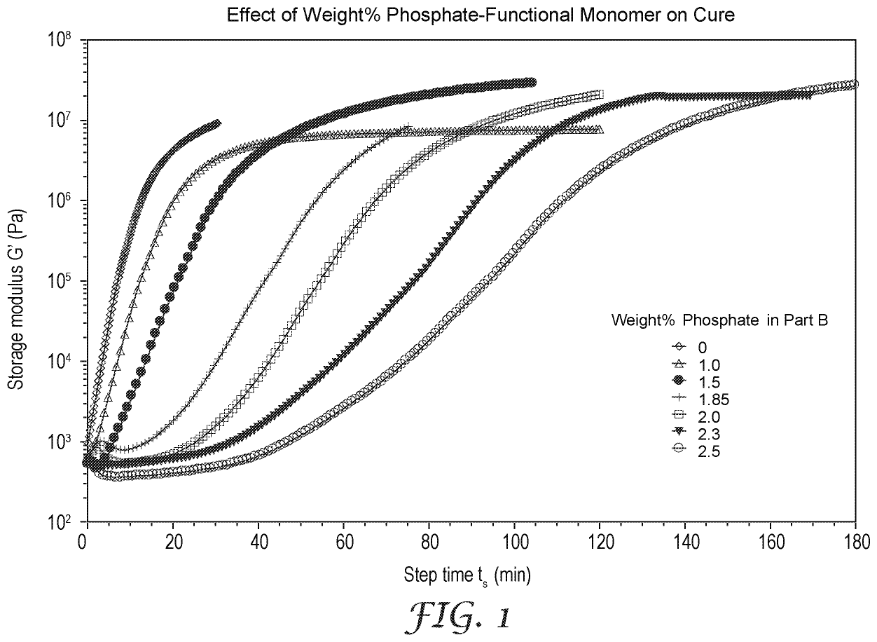

It has now been found that varying the wt. % of the acrylic monomer comprising a phosphate or phosphonate group in the formulation has a surprising effect on the cure speed and “open time” of the adhesive; increasing the amount of such a monomer in the second part can decrease the cure speed and increase the open time. In some embodiments, the acrylic monomer comprising a phosphate or phosphonate group is present in an amount of 1.85 wt. % to 2.15 wt. %, based on the total weight of the second part. In these embodiments, the adhesive typically and advantageously has an open time of at least about 15 to 20 minutes after the first part and the second part are mixed. In some embodiments, the acrylic monomer comprising a phosphate or phosphonate group is present in an amount of 2.25 wt. % to 3 wt. %, based on the total weight of the second part. In these embodiments, the adhesive typically and unexpectedly has an open time of at least about 40 to 60 minutes after the first part and the second part are mixed. Without the acrylic monomer comprising a phosphate or phosphonate group, the adhesive typically has an open time of less than five minutes after the first part and the second part are mixed. These effects can be observed in the rheological data shown in FIG. 1. In the curves, open time can be seen as the time until an increase in the slope occurs. This time is similar to the open time as determined using overlap shear evaluations described herein. Open time is sometimes referred to as working time.

The second part of the two-part adhesive composition includes a crosslinker having two or more acrylate groups, methacrylate groups, or a combination thereof. In some embodiments, both the first part and the second part of the two-part adhesive composition include a crosslinker having two or more acrylate groups, methacrylate groups, or a combination thereof. In some embodiments, the second part of the two-part adhesive composition includes a crosslinker having two or more acrylate groups, methacrylate groups, or a combination thereof, but the first part does not include such a crosslinker. Suitable crosslinkers having two or more acrylate groups, methacrylate groups, or a combination thereof include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, dimethacrylates of any of the foregoing diacrylates, and combinations thereof. Further suitable crosslinkers include polyacrylate esters of polyols, such as glycerol triacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable crosslinkers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. In some embodiments, the crosslinker is a non-cyclic crosslinker having two or more acrylate groups, methacrylate groups, or a combination thereof. Non-cyclic means that the crosslinker does not contain any aromatic or non-aromatic rings. For example, non-cyclic crosslinkers do not include aromatic rings, non-aromatic carbocyclic rings, or heterocyclic rings (that is, rings including N, O, or S as a member of the ring) of any size. The amount of the crosslinker present in the second part may be 5 wt. % to 35 wt. %, 10 wt. % to 35 wt. %, or 15 wt. % to 30 wt. %, based on the total weight of the second part. These amounts may each be useful amounts of crosslinker in the first part, based on the total weight of the first part. In some embodiments, the first part is free of a crosslinker having two or more acrylate groups, methacrylate groups, or a combination thereof.

In some embodiments, the second part of the two-part adhesive composition includes an acrylic monomer comprising a carboxylic acid group. In some embodiments, both the first part and the second part of the two-part adhesive composition include an acrylic monomer comprising a carboxylic acid group. In some embodiments, the second part of the two-part adhesive composition includes an acrylic monomer comprising a carboxylic acid group, but the first part does not include an acrylic monomer comprising a carboxylic acid group. In some embodiments, the acrylic monomer comprising a carboxylic acid group is present in the second part in an amount of 5 wt. % to 20 wt. %, 5 wt. % to 15 wt. %, or 7.5 wt. % to 12.5 wt. %, based on the total weight of the second part. These amounts may each be useful amounts of acrylic monomer comprising a carboxylic acid group in the first part, based on the total weight of the first part. In some embodiments, the first part is free of an acrylic monomer comprising a carboxylic acid group. Examples of suitable acrylic monomers comprising a carboxylic acid group include methacrylic acid, acrylic acid, β-acryloyl oxyethyl hydrogen succinate and β-methacryloyl oxyethyl hydrogen succinate. Many acrylic monomers comprising a carboxylic acid group are available from commercial sources, for example, methacrylic acid available from Evonik Performance Materials GmbH under the trade designation “VISIOMER GMAA” and β-methacryloyl oxyethyl hydrogen succinate available from Shin-Nakamura Co. Ltd., Arimoto, Japan, under the trade designation “NK ESTER SA”. In some embodiments, the acrylic monomer comprising a carboxylic acid group is at least one of acrylic acid or methacrylic acid. In some embodiments, the acrylic monomer comprising a carboxylic acid group is methacrylic acid.

In some embodiments, at least one of the first part or the second part of the two-part adhesive composition includes an additional acrylic monomer, such as any of those described below. In some embodiments, the second part of the two-part adhesive composition includes an additional acrylic monomer, but the first part does not include an additional acrylic monomer. In some embodiments, the additional acrylic monomer is present in an amount of at least 5 wt. % and up to 25 wt. %, 20 wt. %, 15 wt. %, or 10 wt. %, based on the total weight of the second part or the first part, respectively.

Examples of suitable additional acrylic monomers include those comprising a hydroxyl group such as 2-hydroxyethyl acrylate, 2-hydroxyethyl methacrylate, 2- and 3-hydroxypropyl acrylate, 2- and 3-hydroxypropyl methacrylate, hydroxybutyl acrylate, hydroxybutyl methacrylate, caprolactone mono(meth)acrylate, available under the trade designation “SR-495B” from Sartomer and other poly(e-caprolactone) mono[2-(meth)acryloxy ethyl] esters, poly(e-caprolactone) mono[2-acryloxy ethyl] esters, 2-hydroxy-3-alkyloxy methacrylate, 2-hydroxy-3-alkyloxy acrylate, and polyethylene glycol mono acrylates and methacrylates. Many acrylic monomers comprising a hydroxyl group are available from commercial sources, for example, 2-hydroxyethyl methacrylate (available from Evonik Performance Materials GmbH under the trade designations “VISIOMER HEMA 97” and “VISIOMER HEMA 98”), hydroxypropyl methacrylate (available from Evonik Performance Materials GmbH under the trade designations “VISIOMER HPMA 97” and “VISIOMER HPMA 98”), ultra-high purity 2-hydroxyethyl methacrylate (available from Evonik Performance Materials GmbH under the trade designation “VISIOMER UHP HEMA”), polypropylene glycol monomethacrylate (available from Miwon North America, Exton, Pennsylvania, under the trade designation “MIRAMER M1051”), and CH₂═CHC(O)O(CH₂CH₂O)₇₋₉H available, for example, from Nippon Oil & Fats Company, Tokyo, Japan under the trade designation “BLEMMER”. The first part, the second part, or both may also be free of monomers comprising a hydroxyl group, including any of those described above.

Further examples of suitable additional acrylic monomers include at least one of an alkyl acrylate or methacrylate. The alkyl group of the alkyl acrylate or methacrylate may be straight-chain, branched, or cyclic (including polycyclic) and may have 2 to 14, 2 to 12, or 2 to 10 carbon atoms. Examples include lauryl methacrylate and isobornyl methacrylate. Such monomers are available from a variety of commercial sources, for example, isobornyl acrylate available from Sartomer under the trade designation “SR506”, or from Evonik Performance Materials GmbH under the trade designation “VISIOMER IBOA”, isobornyl methacrylate available from Sartomer under the trade designation “SR423A” or from Evonik Performance Materials GmbH under the trade designation “VISIOMER IBOMA”, and lauryl methacrylate available from BASF, Florham Park, NJ, under the trade designation “LMA 1214 F”. The first part, the second part, or both may also be free of alkyl acrylate and methacrylate that are straight-chain, branched, or cyclic (including polycyclic) and have 2 to 14, 2 to 12, or 2 to 10 carbon atoms.

Further examples of suitable additional acrylic monomers include 2-phenoxyethyl(meth)acrylate, cyclohexyl (meth)acrylate, benzyl (meth)acrylate, alkoxylated lauryl (meth)acrylate, alkoxylated phenol (meth)acrylate, alkoxylated tetrahydrofurfuryl (meth)acrylate, caprolactone (meth)acrylate, cyclic trimethylolpropane formal (meth)acrylate, ethylene glycol methyl ether (meth)acrylate, ethoxylated nonyl phenol (meth)acrylate, isodecyl (meth)acrylate, isooctyl (meth)acrylate, octadecyl (meth)acrylate (stearyl (meth)acrylate), tetrahydrofurfuryl (meth)acrylate, tridecyl (meth)acrylate, tetrahydrofurfuryl (meth)acrylate, allyl (meth)acrylate, methyl (meth)acrylate, ethyl (meth)acrylate, n-propyl (meth)acrylate, n-butyl (meth)acrylate, isobutyl (meth)acrylate, n-hexyl (meth)acrylate, 2-ethylhexyl (meth)acrylate, n-octyl (meth)acrylate, n-decyl (meth)acrylate, n-dodecyl (meth)acrylate, 2-methoxyethyl (meth)acrylate, 2-ethoxyethyl (meth)acrylate, 2- or 3-ethoxypropyl (meth)acrylate, 2-(2-ethoxyethoxy)ethyl acrylate, glycidyl (meth)acrylate, N-(2-(2-oxo-1-imidazolidinyl)ethyl) methacrylamide, and methacrylamidoethyl ethylene urea (“MAEEU”) available from Solvay Specialty Polymers USA, LLC under the trade designation “SIPOMER WAM II”), and combinations thereof. The first part, the second part, or both may also be free of any of these monomers.

In some embodiments, at least one of the first part or the second part of the two-part adhesive composition of the present disclosure may include other components useful, for example, in sealant and adhesive compositions. For example, at least one of the first part or the second part can include at least one of plasticizers (e.g., aliphatic and aromatic hydrocarbons, alkyl esters, alkyl ethers, aryl esters, and aryl ethers), tackifiers, corrosion inhibitors, UV stabilizers, antioxidants, flame retardants, thixotropic agents such as fumed silica, dyes, pigments (e.g., ferric oxide, brick dust, carbon black, and titanium oxide), reinforcing agents (e.g., silica, magnesium sulfate, calcium sulfate, and beryllium aluminum silicate), clays such as bentonite, other suitable filler (e.g., glass beads, talc, and calcium metasilicate), dispersing agents, wetting agents, waxes, adhesion promoters (e.g., silane coupling agents), antistatic agents, thermally and/or electrically conductive particles, foaming agents, and hollow polymeric or ceramic microspheres (e.g., glass bubbles). In some embodiments, at least one of the first part or the second part of the two-part adhesive composition of the present disclosure includes a filler. Examples of fillers useful for some embodiments of the two-part composition of the present disclosure include at least one of a micro-fibrillated polyethylene, a fumed silica, a talc, a wollastonite, an aluminosilicate clay (e.g., halloysite), phlogopite mica, calcium carbonate, kaolin clay, metal oxides (e.g., barium oxide, calcium oxide, magnesium oxide, zirconium oxide, titanium oxide, zinc oxide), nanoparticle fillers (e.g., nanosilica, nanozirconia). These components may be present in at least one of the first part or the second part in any suitable amount. The first part, the second part, or both may also be free of any of these components.

In some embodiments, the two-part adhesive composition is free of silsesquioxanes or comprises not more than 0.05 weight percent of a silsesquioxane, based on the total weight of the two-part adhesive composition. In some embodiments, the two-part adhesive composition is free of polyhedral oligomeric silsesquioxanes or comprises not more than 0.05 weight percent of a polyhedral oligomeric silsesquioxane, based on the total weight of the two-part adhesive composition.

In some embodiments, at least one of the first part or the second part includes fumed silica. In some embodiments, the fumed silica is present in the first part in an amount of 1 wt. % to 10 wt. %, 2 wt. % to 8 wt. %, or 3 wt. % to 7 wt. %, based on the total weight of the first part. If present in the second part, these amounts fumed silica may each be useful in the second part, based on the total weight of the second part. In some embodiment, at least one of the first part or the second part includes a pigment, which may be any of those described above. In some embodiments, the second part includes carbon black. Any suitable amount of pigment (in some embodiments, carbon black) may be useful. Useful levels of pigment or carbon black include up to 2 wt. %, 1.5 wt. %, 1 wt. %, or 0.5 wt. %, based on the total weight of the second part. In some embodiments, the second part includes glass beads. Any suitable amount of glass beads may be useful, including up to 5 wt. %, 3 wt. %, 2 wt. %, or 1 wt. %, based on the total weight of the second part.

In some embodiments, the first part of the two-part adhesive composition of the present disclosure further includes starch. In some embodiments, both the first part and the second part of the two-part adhesive composition include starch. In some embodiments, the first part of the two-part adhesive composition includes starch, but the second part does not include starch. The starch may be a natural starch or a treated starch. Examples of suitable natural starches include corn, tapioca, rice, wheat, soybean, pea, potato, sweet potato, sago, and amaranth starch. Examples of treated starches include those obtained by chemically or physically modifying any of the natural starches described above. Examples of treated starch obtained by chemical modification include etherified starch, esterified starch, crosslinked starch, dextrin, and oxidized starch. Examples of physical modifications of starch include electromagnetic radiation treatment, radio frequency treatment, and moist heat treatment. In some embodiments, the starch is corn starch. In some embodiments, the starch is present in the first part in an amount of 5 wt. % to 20 wt. %, 5 wt. % to 15 wt. %, or 7.5 wt. % to 12.5 wt. %, based on the total weight of the first part. These amounts may each be useful amounts of starch in the second part, based on the total weight of the second part. In some embodiments, the starch useful for practicing the present disclosure has an average particle size of 1 micrometer (μm) to 200 μm or from 5 μm to 100 μm.

In some embodiments, the second part of the two-part adhesive composition of the present disclosure further includes a wax. In some embodiments, both the first part and the second part of the two-part adhesive composition include a wax. In some embodiments, the second part of the two-part adhesive composition includes a wax, but the first part does not include a wax. A wax can be useful, for example, for helping the surface curing of an acrylate adhesive composition when in contact with air, and for reducing the evaporation of methyl methacrylate. The wax may be any common wax known in the art. Examples of suitable waxes include paraffin waxes, microcrystalline waxes, polyethylene waxes, polypropylene waxes, Fischer-Tropsch waxes, oxidized Fischer-Tropsch waxes, functionalized waxes, fatty amide waxes, and any combination of these. Examples of commercially available waxes include those obtained under the trade designations “SASAOLWAX H1” from Sasol Wax, “AC-400” and “AC-575P” from Honeywell, “MC-400” from Marcus Oil Company, “EPOLENE C-18” from Eastman Chemical, “Wax 58” from Sinopharm, and “BYK-S 782”, from BYK USA Inc. The wax can be present in the second part, for example, in an amount of at least 0.5 wt. %, 1 wt. %, 1.5 wt. %, or 1.9 wt. % and up to 5 wt. %, 4 wt. %, or 3 wt. %, based on the total weight of the second part. These amounts may also be useful in the first part if wax is included in the first part.

The present disclosure provides a first part of a two-part adhesive composition. The first part includes methyl methacrylate, a block copolymer of methyl methacrylate and at least one of a C₄-C₉ alkyl acrylate or methacrylate or a C₂₋₄ hydroxyalkyl acrylate or methacrylate, a free-radical initiator comprising at least one of a peroxide initiator or a hydroperoxide initiator, a free-radical inhibitor, and starch. Each of these components can be any of those described above in any of their embodiments. In some embodiments, the block copolymer is a poly(methyl methacrylate)-poly(n-butyl(meth)acrylate)-poly(methyl methacrylate) triblock copolymer. In some embodiments, the free-radical initiator is cumene hydroperoxide. In some embodiments, the free-radical initiator is present in an amount from 0.5 weight percent to 3.5 weight percent, based on the total weight of the first part, and the free-radical inhibitor is present in an amount that is at least half of the amount by weight of the free-radical initiator. In some embodiments, the starch is corn starch. In some embodiments, typically and advantageously, the first part is stable for at least one month at 120 °F (49 °C) as shown in the Examples, below. The first part can be mixed with a second part as disclosed herein. The first part may also be usefully combined with a different composition including a different reducing agent to form an adhesive composition. Suitable reducing agents include any of the amines, thioureas, and other metal salts described above and combinations thereof.

The present disclosure provides a second part of a two-part adhesive composition. The second part comprises monomers and vanadyl acetylacetonate. The monomers consist of methyl methacrylate; a non-cyclic crosslinker having two or more acrylate groups, methacrylate groups, or a combination thereof; an acrylic monomer comprising at least one of a phosphate or phosphonate group; and methacrylic acid. The non-cyclic crosslinker having two or more acrylate groups, methacrylate groups, or a combination thereof and the acrylic monomer comprising at least one of a phosphate or phosphonate group can be any of those described above in any of their embodiments. It should be understood that while other components may be present in the second part, when the monomers are said to consist of the list described above, no other monomers may be present in the second part. In some embodiments, the second part further comprises an elastomer as described above in any of its embodiments. In some embodiments, the second part is essentially free of thioureas, amines, and other metal salt reducing agents. In some embodiments, the acrylic monomer comprising at least one of a phosphate or phosphonate group is present in an amount in a range from 1.85 weight percent to 2.15 weight percent, based on the total weight of the second part. In some embodiments, the acrylic monomer comprising a phosphate or phosphonate group is present in an amount of 2.25 wt. % to 3 wt. %, based on the total weight of the second part. The second part can be mixed with a first part as disclosed herein. The second part may also be usefully combined with a different composition including a different oxidizing agent to form an adhesive composition.

The first part and the second part of the two-part composition can be combined at any suitable volume ratio. For example, the first part and the second part can be combined at a volume ratio in a range of from about 5:1 to about 1:5, about 2:1 to about 1:2, about 1.5:1 to about 1:1.5, or about 1:1. It is challenging to make two-part, free-radically curing adhesive compositions with approximately equal volumes of the first part and the second part because such compositions generally need to include monomer in the same part as a free-radical initiator.

The first part and the second part can be located in any suitable system or kit for containing, mixing, and dispensing the first part and the second part. The system can be suited for large-scale industrial applications or small-scale applications. Either system can include first and second chambers for holding the respective first part and second part. The chambers can be sized for any application and formed from plastic, metal, or any other suitable material. A dispenser can be adapted to receive the first part and the second part and dispense a mixture of the first part and the second part on a substrate. The dispenser can function to facilitate mixing of the first part and the second part, or a mixing chamber can be disposed upstream of the dispenser and in fluid communication with the first chamber and the second chamber. The mixing chamber can be adapted to rotate in order to facilitate mixing, or the mixing chamber can include a number of baffles to induce rotation of the first part and the second part.

To facilitate movement of the first part and the second part, the system can include elements such as one or more plunger or one or more pumps. The one or more plungers can be useful for systems that are handheld. In these embodiments, a user can push one or two plungers, between at least a first and a second position, to force the first part and the second part through the system. If there is one plunger, then the first part and the second part can be dispensed at equal volumes or at a predetermined volume ratio.

Pumps can be useful in industrial applications where large volumes or a continuous supply of the first part and the second part are dispensed. These systems can include one or more pumps that are in fluid communication with the first and second chambers. The one or more pumps can be located downstream of the first and second chambers but upstream of the mixing chamber. In embodiments of the system in which there are two pumps in fluid communication with respective first and second chambers, the pumps can be adapted or controlled to pump an equal volume of the first part and the second part or to pump different quantities of each part according to a predetermined volume ratio.

Compositions of the present disclosure may be used, for example, to bond a first substrate to a second substrate to provide a bonded article. Thus, the present disclosure provides a method of making a bonded article. The method includes combining the first part and the second part of the two-part adhesive composition disclosed herein to provide an adhesive, applying the adhesive on at least one of the first substrate or the second substrate, adhering the first substrate and the second substrate using the adhesive, and allowing the adhesive to at least partially cure to make the bonded article. Many types of substrates may be bonded with compositions of the present disclosure such as metal (e.g., stainless steel or aluminum), glass (e.g., which may be coated with indium tin oxide), a polymer (e.g., a plastic, rubber, thermoplastic elastomer, or thermoset), or a composite. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic), metal matrix compositions, and ceramic matrix composites. Useful polymeric substrates that can be bonded include polymers such as acrylonitrile butadiene styrene (ABS), polycarbonate (PC), PC/ABS blends, polyvinyl chloride (PVC), polyester, polyurethane (PUR), thermoplastic elastomers (TPE), polystyrene, poly(methyl) methacrylate (PMMA), polyvinyl chloride (PVC), and combinations thereof. The substrate may also include a metal coating on such polymers. The composition of the present disclosure can be useful, for example, for bonding electronic articles and automotive and aerospace components.

After at least partial curing, a crosslinked composition is generally obtained, and if sufficiently cured, it may be suitable for use as a structural adhesive to bond two adherends. In such use, the composition is typically sandwiched between the adherends and at least partially cured; for example, sufficient to achieve at least a desired level of bond strength.

While it is not practical to enumerate a particular curing temperature suitable for all situations, generally suitable temperatures are in a range from about 23 °C to about 200 °C. In some embodiments, advantageously, the composition can be cured at room temperature (e.g., 23 °C to 30 °C), for at least 60 minutes, 90 minutes, 120 minutes, 6 hours, 12 hours, 24 hours, 48 hours, or 72 hours for example, to at least partially cure the composition.

As shown in the Examples, below, the two-part adhesive composition of the present disclosure can be cured at room temperature to provide an adhesive having a glass transition temperature in a range 125 °C to 155 °C, 130 °C to 150 °C, or 140 °C to 145 °C. In many advantageous embodiments, the adhesive made from mixing the first part and the second part of the two-part adhesive composition bonds to abraded aluminum and provides a remarkable overlap shear strength of at least 2000 psi. The adhesive bonds can remarkably withstand high temperature and freezing with 90% retention of the overlap shear strength as shown in the Examples below. The adhesive can bond a wide variety of materials, including metal and fiber-reinforced plastic, with good bond strength for example, even at high temperatures and, in some embodiments, in water or high humidity.

### SOME EMBODIMENTS OF THE DISCLOSURE

In a first embodiment, the present disclosure provides a two-part adhesive composition comprising a first part comprising methyl methacrylate; a block copolymer of methyl methacrylate and at least one of a C₄-C₉ alkyl acrylate or methacrylate or a C₂₋₄ hydroxyalkyl acrylate or methacrylate; a free-radical initiator comprising at least one of a peroxide initiator or a hydroperoxide initiator; and a free-radical inhibitor, and a second part comprising methyl methacrylate; a crosslinker having two or more acrylate groups, methacrylate groups, or a combination thereof; an acrylic monomer comprising at least one of a phosphate or phosphonate group; and vanadyl acetylacetonate. In a second embodiment, the present disclosure provides the two-part adhesive composition of the first embodiment, wherein the first part further comprises starch. In a third embodiment, the present disclosure provides the two-part adhesive composition of the second embodiment, wherein the starch is corn starch. In a fourth embodiment, the present disclosure provides the two-part adhesive composition of any one of the first to third embodiments, wherein the block copolymer is a poly(methyl methacrylate)-poly(n-butyl (meth)acrylate)-poly(methyl methacrylate) triblock copolymer. In a fifth embodiment, the present disclosure provides the two-part adhesive composition of any one of the first to fourth embodiments, wherein the free-radical initiator is the hydroperoxide initiator, and wherein the hydroperoxide initiator is cumene hydroperoxide. In a sixth embodiment, the present disclosure provides the two-part adhesive composition of any one of the first to fifth embodiments, wherein the second part further comprises an elastomer. In a seventh embodiment, the present disclosure provides the two-part adhesive composition of any one of the first to sixth embodiments, wherein the second part further comprises at least one of acrylic acid or methacrylic acid, in some embodiments, methacrylic acid. In an eighth embodiment, the present disclosure provides a two-part adhesive composition comprising a first part comprising methyl methacrylate, a poly(methyl methacrylate)-poly(n-butyl (meth)acrylate)-poly(methyl methacrylate) triblock copolymer; cumene hydroperoxide; a free-radical inhibitor; corn starch; and fumed silica, and a second part comprising methyl methacrylate; methacrylic acid; a crosslinker having two or more acrylate groups, methacrylate groups, or a combination thereof; an acrylic monomer comprising at least one of a phosphate or phosphonate group; at least one elastomer; a free-radical inhibitor; vanadyl acetylacetonate; a wax; and a pigment.

In a ninth embodiment, the present disclosure provides the two-part adhesive composition of any one of the first to eighth embodiments, wherein the crosslinker having two or more acrylate groups is a non-cyclic crosslinker. In a tenth embodiment, the present disclosure provides the two-part adhesive composition of any one of the first to ninth embodiments, wherein the first part comprises 25 wt. % to 65 wt. %, 35 wt. % to 55 wt. %, or 40 wt. % to 50 wt. % methyl methacrylate, and the second part includes 20 wt. % to 60 wt. %, 25 wt. % to 50 wt. %, or 30 wt. % to 45 wt. % methyl methacrylate, based on the total weight of the first part and the second part, respectively, of the two-part adhesive composition. In an eleventh embodiment, the present disclosure provides the two-part adhesive composition of any one of the first to tenth embodiments, wherein the free-radical initiator is present in an amount from 0.5 weight percent to 3.5 weight percent, based on the total weight of the first part. In a twelfth embodiment, the present disclosure provides the two-part adhesive composition of any one of the first to eighth embodiments, wherein the free-radical inhibitor is present in an amount that is at least half of the amount by weight of the free-radical initiator. In a thirteenth embodiment, the present disclosure provides the two-part adhesive composition of any one of the first to twelfth embodiments, wherein the acrylic monomer comprising at least one of a phosphate or phosphonate group is present in an amount in a range from 1.85 weight percent to 2.15 weight percent or in a range from 1.85 weight percent to 3 weight percent, based on the total weight of the second part. In a fourteenth embodiment, the present disclosure provides the two-part adhesive composition of any one of the first to twelfth embodiments, wherein the acrylic monomer comprising at least one of a phosphate or phosphonate group is present in an amount in a range from 2.25 weight percent to 3.5 weight percent or in a range from 2.25 weight percent to 3 weight percent, based on the total weight of the second part. In a fifteenth embodiment, the present disclosure provides the two-part adhesive composition of any one of the first to fourteenth embodiments, wherein the two-part adhesive composition is free of acid chloride or comprises not more than 0.05 weight percent of an acid chloride, based on the total weight of the two-part adhesive composition. In a sixteenth embodiment, the present disclosure provides the two-part adhesive composition of any one of the first to fifteenth embodiments, wherein the second part is essentially free of thioureas, amines, and other metal salt reducing agents and/or wherein monomers in the second part consist of methyl methacrylate; the crosslinker having two or more acrylate groups, methacrylate groups, or a combination thereof; the acrylic monomer comprising at least one of a phosphate or phosphonate group; and methacrylic acid. In a seventeenth embodiment, the present disclosure provides the two-part adhesive composition of any one of the first to sixteenth embodiments, wherein the first part and the second part are packaged in a first container and a second container, respectively, and wherein a volume ratio of the first container to the second container is in a range from 1.5:1 to 1:1.5.

In an eighteenth embodiment, the present disclosure provides a method of making a bonded article comprising a first substrate and a second substrate, the method comprising combining the first part and the second part of the two-part adhesive composition of any one of the first to seventeenth embodiments to provide an adhesive, applying the adhesive to at least one of the first substrate or the second substrate, adhering the first substrate and the second substrate using the adhesive, and allowing the adhesive to at least partially cure to make the bonded article. In a nineteenth embodiment, the present disclosure provides the method of the eighteenth embodiment, wherein the first part and the second part are combined in a volume ratio in a range from 1.5:1 to 1:1.5. In a twentieth embodiment, the present disclosure provides the method of the eighteenth or nineteenth embodiment, wherein at least one of the first substrate or the second substrate comprises at least one of metal, glass, a polymer, or a composite. In a twenty-first embodiment, the present disclosure provides an article made by the method of any one of the eighteenth to twentieth embodiments.

In a twenty-second embodiment, the present disclosure provides a first part of a two-part adhesive composition, the first part comprising methyl methacrylate, a block copolymer of methyl methacrylate and at least one of a C₄-C₉ alkyl acrylate or methacrylate or a C₂₋₄ hydroxyalkyl acrylate or methacrylate, a free-radical initiator comprising at least one of a peroxide initiator or a hydroperoxide initiator, a free-radical inhibitor, and starch. In a twenty-third embodiment, the present disclosure provides the first part of a two-part adhesive composition of the twenty-second embodiment, wherein the starch is corn starch. In a twenty-fourth embodiment, the present disclosure provides the first part of the two-part adhesive composition of the twenty-second or twenty-third embodiments, wherein the block copolymer is a poly(methyl methacrylate)-poly(n-butyl(meth)acrylate)-poly(methyl methacrylate) triblock copolymer. In a twenty-fifth embodiment, the present disclosure provides the first part of the two-part adhesive composition of any one of the twenty-second to twenty-fourth embodiments, wherein the free-radical initiator is the hydroperoxide initiator, and wherein the hydroperoxide initiator is cumene hydroperoxide. In a twenty-sixth embodiment, the present disclosure provides the first part of the two-part adhesive composition of any one of the twenty-second to twenty-fifth embodiments, wherein the first part comprises 25 wt. % to 65 wt. %, 35 wt. % to 55 wt. %, or 40 wt. % to 50 wt. % methyl methacrylate, based on the total weight of the first part of the two-part adhesive composition. In a twenty-seventh embodiment, the present disclosure provides the first part of the two-part adhesive composition of any one of the twenty-second to twenty-sixth embodiments, wherein the free-radical initiator is present in an amount from 0.5 weight percent to 3.5 weight percent, based on the total weight of the first part. In a twenty-eighth embodiment, the present disclosure provides the first part of the two-part adhesive composition of any one of the twenty-second to twenty-seventh embodiments, wherein the free-radical inhibitor is present in an amount that is at least half of the amount by weight of the free-radical initiator. In a twenty-ninth embodiment, the present disclosure provides the first part of the two-part adhesive composition of any one of the twenty-second to twenty-eighth embodiments, wherein the first part is free of acid chloride or comprises not more than 0.05 weight percent of an acid chloride, based on the total weight of the first part of the two-part adhesive composition.

In a thirtieth embodiment, the present disclosure provides a second part of a two-part adhesive composition, the second part comprising monomers and vanadyl acetylacetonate, wherein the monomers consist of methyl methacrylate; a non-cyclic crosslinker having two or more acrylate groups, methacrylate groups, or a combination thereof; an acrylic monomer comprising at least one of a phosphate or phosphonate group; and methacrylic acid. In a thirty-first embodiment, the present disclosure provides the second part of the two-part adhesive composition of the thirtieth embodiment, wherein the second part further comprises an elastomer. In a thirty-second embodiment, the present disclosure provides the second part of the two-part adhesive composition of the thirtieth or thirty-first embodiment, wherein the acrylic monomer comprising at least one of a phosphate or phosphonate group is present in an amount in a range from 1.85 weight percent to 2.15 weight percent or in a range from 1.85 weight percent to 3 weight percent, based on the total weight of the second part. In a thirty-third embodiment, the present disclosure provides the two-part adhesive composition of any one of the thirtieth to thirty-first embodiments, wherein the acrylic monomer comprising at least one of a phosphate or phosphonate group is present in an amount in a range from 2.25 weight percent to 3.5 weight percent or in a range from 2.25 weight percent to 3 weight percent, based on the total weight of the second part. In a thirty-fourth embodiment, the present disclosure provides the two-part adhesive composition of any one of the thirtieth to thirty-third embodiments, wherein the second part includes 20 wt. % to 60 wt. %, 25 wt. % to 50 wt. %, or 30 wt. % to 45 wt. % methyl methacrylate, based on the total weight of the second part of the two-part adhesive composition. In a thirty-fifth embodiment, the present disclosure provides the second part of the two-part adhesive composition of any one of the thirtieth to thirty-fourth embodiments, wherein the second part is essentially free of thioureas, amines, and other metal salt reducing agents.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. The following abbreviations are used in this section: in =inches, g=grams, kg=kilogram, lb=pound, kN=kilo Newtons, N=Newtons, lbr=pound force, min=minutes, s=seconds, °C=degrees Celsius, °F=degrees Fahrenheit, Hz=hertz, J=Joules, °=degree angle, cm=centimeters, mm=millimeters, psi=pounds per square inch, and rpm=revolutions per minute.

TABLE 1
Materials List

| Name | Description |
|---|---|
| MMA | Methyl methacrylate, obtained under the trade designation “VISIOMER MMA”, |
| | from Evonik Performance Materials GmbH, Essen, Germany |
| Starch | 100% pure Corn Starch, obtained under the trade designation “Essential |
| | Everyday”, distributed by UNFI, Providence, RI |
| MAA | Methacrylic acid, obtained from Alfa Aesar, Tewksbury, MA |
| CSP | Core Shell particle: methylmethacrylate-butadiene-styrene (MBS) core-shell |
| | toughening agent, obtained under the trade designation “CLEARSTRENGTH |
| | 233”, from Arkema Inc., King of Prussia, PA |
| NBR | Acrylonitrile-butadiene rubber (NBR) with calcium stearate as separating agent, |
| | obtained under the trade designation “BAYMOD N 34.52”, from Arlanxeo |
| | Corporation, Pittsburgh, PA |
| BHT | 2,6-Di-tert-butyl-4-methylphenol; obtained from Thermo Fisher Scientific, Fair |
| | Lane, NJ |
| VaAcAc | Vanadyl acetylacetonate; obtained from Sigma-Aldrich Co., St. Louis, MO |
| Wax | Modified waxes, obtained under the trade designation “BYK-S 782”, from BYK |
| | USA Inc., Wallingford, CT |
| MEHQ | 4-methoxy-phenol, obtained from Sigma-Aldrich Co. |
| Phosphate | Phosphate ester of PPG monomethacrylate, obtained under the trade designation |
| | “SIPOMER PAM-200”, from Solvay Novecare, Cranbury, NJ |
| XL | Triethylene glycol dimethacrylate, obtained under the trade designation |
| | “MIRAMER M233”, from Miwon Specialty Chemical Co., Gwanggyo, South |
| | Korea |
| Silica | Hydrophobic amorphous pyrogenic silica, obtained under the trade designation |
| | “HDK H18”, from Wacker Silicones, Muchen, Germany |
| CHP | Cumene Hydroperoxide, technical grade, 80%; obtained from Sigma-Aldrich Co. |
| CB | Carbon black, obtained under the trade designation “MONARCH 120”, from |
| | Cabot Corp., Billerica, MA |
| GS | 0.150-0.212 mm Soda lime glass spheres (GL0191B4/150-212), obtained from |
| | MoSci Corporation, North, Rolla, MO |
| BCP | Block copolymer (polymethyl methacrylate - poly butyl acrylate - polymethyl |
| | methacrylate), obtained under the trade designation “KURARITY LA-2330”, |
| | from Kuraray Co. LTD, Tokyo, Japan |
| Copolymer | Copolymer of methyl methacrylate and butyl acrylate; obtained under the trade |
| | designation “DIANAL TB-322”, from Mitsubishi Chemical America, Inc, |
| | Specialty Resins Division, Pasadena, TX |
| MBTBMP | 2,2′-Methylenebis(6-tert-butyl-4-methylphenol), obtained from Sigma-Aldrich Co. |

### Test Methods

### Overlap Shear (OLS) Test

The mixed adhesives Illustrative Example M-1 and Examples M-2 through M-9 made from Example A-1 and Illustrative Example B-1 and Examples B-2 through B-9 were used to prepare overlap shear test samples on aluminum (Al) substrates and on fiber reinforced plastic (FRP). Aluminum coupon samples (obtained from Joseph t. Ryerson and Son, Inc., Coon Rapids, MN) were 2.54×10.16×0.16 cm (1 in×4 in× 1/16 in) and were prepared using one of three methods: (1) only wiped with methyl ethyl ketone (MEK) solvent prior to bonding, or (2) manually abraded with a pad with the trade designation “SCOTCH BRITE” (3M Company, St. Paul, MN) followed by wiping with MEK solvent prior to bonding, or (3) chemically etched with a sulfuric acid and sodium dichromate solution. All Green and Red FRP substrates (obtained from Plastics International, Eden Prairie, MN) were 6.35×25.4×101.6 mm (¼×1×4 in). The Green FRP substrate was available as a laminate G-10/FR-4 glass epoxy and the Red FRP was available under the trade designation “GPO-3” (NEMA grade glass-mat reinforced polyester). A 1.27 cm (½ in) overlap was used when preparing the overlap shear samples. The bond line was clamped with binder clips during cure and the clips were removed after 24 hours at 25 °C. Testing for overlap shear was run on a Material Testing Systems Insight 30 EL instrument (obtained from MTS Systems Corporation, Eden Prairie, MN) with a 5,620 lb (25 kN) load cell for aluminum samples and a 2250 lb (10 kN) load cell for plastic samples. Aluminum overlap shear samples were run at 2.54 mm (0.1 in)/min and plastic overlap shear samples were run at 50.8 mm (2 in)/min. The peak stress values (psi) were reported, and each value was an average of three specimens.

### Side Impact Test

All bonds were prepared by dispensing the adhesive through a static mixing tip onto chemically etched aluminum coupons. The aluminum coupon samples (obtained from Joseph t. Ryerson and Son, Inc.) were 2.54×10.16×0.16 cm (1 in×4 in× 1/16 in) and were chemically etched with a sulfuric acid and sodium dichromate solution. The Side Impact samples were bonded with a 1.27 cm (0.5 in) overlap. The bond line was clamped with binder clips during cure and the clips were removed after 24 hours at 25 °C (77 °F). The side to be impacted was polished using a grinder to make a sample in which the adhesive and aluminum substrates are flush. The samples were tested on an CP9050 Impact Pendulum (obtained from Instron, Norwood, MA) with the samples held in a clamp and impacted on the edge of the bonded area. The test parameters were ISO 179-1, using a 21.6 J hammer dropped from a 150.0° angle.

### Bell Peel Strength Test

The Bell Peel test was based on ASTM D-3167, using a Material Testing Systems Insight 30 EL instrument (obtained from MTS Systems Corporation) with some modifications. The test sample was prepared using a 1 in×7 in×0.063 in (2.54 cm×17.8 cm×0.16 cm) chemically etched 2024 T3 Alclad aluminum strip (obtained from Erickson Metals of Minnesota, Coon Rapids, MN) and a 1 in×10 in×0.020 in (2.54 cm×25.4 cm×0.051 cm) chemically etched 2024 T3 Alclad aluminum strip (obtained from Erickson Metals of Minnesota). Chemical etching was carried out with a sulfuric acid and sodium dichromate solution. Mixed adhesive was applied to both strips (except for a 3 in (7.6 cm) section of the 10 in (25.4 cm) strip), 17 mil (0.043 cm) spacer beads obtained as 40 mesh, Class VI Soda Lime Glass Spheres from MoSci Corporation were lightly sprinkled onto the adhesive, and the two strips were bonded together using a 15 lb (6.8 kg) roller to press the aluminum strips together. The sample was then held together with eight binder clips for a minimum of 24 hours at room temperature (about 25 °C (77 °F) to cure the adhesive. Note that the 3 in (7.6 cm) section of the thinner aluminum extended beyond the 7 in (17.8 cm) section of the bonded aluminum strips. The sample was tested using a roller drum peel test fixture. The thinner aluminum strip was inserted through the rollers of the floating roller apparatus and clamped by the lower jaw. A 200 lb (0.9 kN) load cell was used, and the sample was tested at a rate of 6 in (15.24 cm)/min. Two or three samples were tested, and the average was reported. The peel strength is reported as lb force/linear inch. The peel strength is reported as an average over 3 in. (7.6 cm) (i.e., 1.5 in (3.8 cm) to 4.5 (11.4 cm)).

### Cataplasm Test

Ten overlap shear samples were prepared using aluminum coupons (obtained from Joseph t. Ryerson and Son, Inc., Coon Rapids, MN) measuring 2.54×10.16×0.16 cm (1 in×4 in × 1/16 in). The coupons were manually abraded with a pad with the trade designation “SCOTCH BRITE” (3M Company, St. Paul, MN) followed by wiping with MEK solvent, prior to bonding. The OLS samples were bonded with a 1.27 cm (0.5 in) overlap and adhesives were let to cure for at least 24 hours. Five of the ten samples were used as controls and were stored in the laboratory under ambient conditions. The remaining five OLS samples were carefully wrapped in 100% cotton batting. The wrapped samples were placed in a bag, with trade designation “ZIPLOC” (S.C. Johnson and Son, Inc., Racine, WI), and distilled water was added, with the amount of water added being ten times the total weight of the cotton batting used. The bag was sealed and placed in a second identical bag which was also sealed. The double bagged sample was then placed on an aluminum tray and placed in an oven set at 71 °C (160 °F) for two weeks. After 2 weeks in the 71 °C (160 °F) oven, the samples were immediately placed in a freezer at −17.8 °C (0 °F) for two hours. And then after 2 hours in the freezer, the samples were let to thaw over two hours, and then immediately the standard Overlap Shear Test was administered at 2.54 mm (0.1 in)/min with a 5620 lb (25 kN) load cell. Both the cataplasm samples and the control samples were tested using the Overlap Shear Test at the same time, and the “% strength retention” was calculated based on the average of all the controls.

### Dynamic Mechanical Analysis (“DMA”)

Films of cured compositions were prepared by extruding the mixed adhesives of Example A-1 and Illustrative Example B-1 and Examples B-2 through B-9 as two-part compositions through a static mixer onto a silicone polyester liner to make mixed adhesive Illustrative Example M-1 and Examples M-2 through M-9. Using a second silicone polyester liner, a film of the adhesive was prepared between both liners at approximately 1 mm (0.04 in) thickness using a simple knife coater. The adhesive film was allowed to cure at room temperature a minimum of 24 hours before testing.

Film samples were cut to approximately 5-6 mm width×1 mm thick×57 mm length (0.20-0.24 in×0.04 in ×2.25 in) and tested on a DMA850 (TA Instruments Inc., New Castle, DE) using a tensile fixture with the following settings: frequency=1 Hz, strain=0.1%, and minimum oscillation force=0.001 N. The film samples were equilibrated to −50 °C (122 °F) and held at that temperature for five minutes, followed by a temperature ramp of 3.0 °C (37.4 °F)/minute to 200 °C (392 °F). The Tan delta peak was reported as the glass transition temperature (Tg).

### Open Time Test for Example M-6

Abraded aluminum overlap shear coupons were used as is described previously in the “Overlap Shear Test” description. Ten overlap shear coupons (five bonded samples) were used for the “t=0” data, and six overlap shear coupons (three bonded samples) were used for each of the t=15, 20, 25 and 30 minute test samples. Adhesive was dispensed onto half of the overlap shear coupons and a stopwatch was started. The bond was immediately closed on the five “t=0” samples. The bonds were closed on the 15, 20, 25 and 30 minute samples at the respective times on the stopwatch. After letting all the overlap shear samples cure for at least 24 hours, the overlap shear samples were tested as is described in the “Overlap Shear Test” above. The average psi values of each of the 15, 20, 25 and 30 minute samples were compared to the average psi value of the “t=0” samples. The average psi values of the 15, 20, 25 and 30 minute samples were then reported as percent of the average psi value of the “t=0” samples.

Open time is defined as the time the mixed adhesive can be left unbonded and still achieve 80% or more of the overlap shear strength that can be achieved when the adhesive is mixed and immediately bonded between to two adherends, in this case, abraded aluminum.

### Accelerated Shelf-Life Test on Part A Examples

Various Part A formulations were loaded into the “10” part side of a 10:1 cartridge, and plungers were placed in both sides of the cartridge. The cartridge was capped and placed in a 120 °F (49 °C) oven. The cartridge was removed from the oven every one to two weeks, allowed to cool, and placed in a cartridge dispenser. Adhesive (2 to 3 mL) was dispensed out of the cartridge. It was noted if the adhesive flowed properly out of the cartridge or if the adhesive was gelled (or partially gelled).

### Rheological Test (Storage Modulus vs Time)

Testing was performed using an ARES-G2 rheometer with TRIOS software (available from TA Instruments). Aluminum disposable parallel plates (25-mm diameter) attached to both upper and lower stainless-steel fixtures and a 0.5 mm gap were used. A frequency of 1 Hz was used at a constant temperature of 25 °C. Also, both axial force adjustment and auto strain adjustment were used in the measurement.

### Rheological Test (Viscosity)

Testing was performed using the ARES-G2 rheometer with TRIOS software. A stainless steel 25 mm diameter 0.09896 rad cone plate was used. The sample was pre-sheared at 20.0 l/s. Then the sample was ramped from 20.0 l/s to 0.1 l/s. The measurement was done at 25 °C.

### PART A EXAMPLES

### Example A-1

Example A-1 was prepared at a 5000-gram scale by combining components in the amounts indicated in Table 2 in a 2-gallon dual shaft Ross mixer (Model No. PVM-2, Charles Ross & Son Company, Hauppauge, NY) equipped with an anchor/scrapper blade and a disperser blade. First, MMA and BHT were added to the mixer and mixing was begun with the anchor blades set at 50 rpm and the disperser blades set at 2683 rpm. After about 5 minutes of mixing, BCP was slowly added over about 8 minutes. Mixing was continued for 32 minutes at which time BCP was all dissolved. Next, Starch was slowly added over about 5 minutes, followed by Silica, which was also slowly added over about 5 minutes. After complete addition of the Silica, the kettle temperature was at 96 °F (36 °C), and the materials were mixed for an additional 25 minutes (anchor blades at 50 rpm and disperser blade at 2683 rpm). Next, CHP was added, and the mixing was continued for another 10 minutes using the same settings. Finally, the material was degassed while mixing was continued, and the vacuum reached about 22 inches (559 mm) of Hg. After degassing, the material was emptied.

### Illustrative Example A-2

Illustrative Example A-2 was prepared at a 125-gram scale by combining components in the amounts indicated in Table 2 in a polypropylene MAX 200 DAC cup (FlackTek, Inc., Landrum, SC). First, MMA, BHT, and Copolymer were combined, and speed mixed with a DAC 400.2 VAC (FlackTek, Inc.) for 4 minutes at 2250 rpm. This mixing was repeated twelve more times until the Copolymer was dissolved. Next, Starch and Silica were added, followed by mixing for 4 min at 2250 rpm, followed by cooling in a freezer for 5 min. The mixture was mixed again at 2250 rpm for 4 minutes, followed by cooling in the freezer for about 5 minutes. Next, CHP was added to the mixture and speed mixed at 1750 rpm for 4 min, followed by cooling in a freezer for 5 minutes. The final adhesive resin mixture was then degassed by capping the mixing cup with a polypropylene lid that contained a vent hole, and high shear mixed under reduced pressure 0.68 psi (~35 Torr) for 2 minutes.

### Illustrative Example A-3

Illustrative Example A-3 was prepared at a 70-gram scale by combining components in the amounts indicated in Table 2 in a polypropylene MAX 100 DAC cup (FlackTek, Inc.). First, MMA and MBTBMP were combined and speed mixed with a DAC 400.2 VAC (FlackTek, Inc.) for 4 minutes at 1500 rpm. Next, NBR was added, followed by mixing for 4 min at 1750 rpm. Next, CSP was added, and the material was mixed in at 2250 rpm for 4 minutes, followed by cooling in a freezer for about 5 minutes. This mixing and cooling were repeated three more times. CHP was then added to the mixture and speed mixed at 1750 rpm for 2 min, followed by cooling in a freezer for 5 minutes. The final adhesive resin mixture was then degassed by capping the mixing cup with a polypropylene lid that contained a vent hole, and high shear mixed under reduced pressure 0.68 psi (~35 Torr) for 2 minutes.

### Illustrative Example A-4

Illustrative Example A-4 was prepared in the same way as Illustrative Example A-3, except that MEHQ was used instead of MBTBMP, and materials were added in the amounts indicated in Table 2.

### Illustrative Examples A-5 and A-6

Illustrative Example A-5 was prepared at a 60-gram scale by combining components in the amounts indicated in Table 2 in a polypropylene MAX 100 DAC cup (FlackTek, Inc.). First, MMA, BHT, NBR and CSP (if present) were combined, and speed mixed with a DAC 400.2 VAC (FlackTek, Inc.) for 4 minutes at 2250 rpm. This mixing was repeated, and the material was cooled in a freezer for 5 min. Next, Starch and Silica were added, followed by mixing for 4 min at 2250 rpm. This mixing was repeated, followed by cooling in a freezer for about 5 minutes. CHP was then added to the mixture and speed mixed at 1750 rpm for 4 min, followed by cooling in a freezer for 5 minutes. The final adhesive resin mixture was then degassed by capping the mixing cup with a polypropylene lid that contained a vent hole, and high shear mixed under reduced pressure 0.68 psi (~35 Torr) for 2 minutes.

### Illustrative Example A-7

Illustrative Example A-7 was prepared at a 60-gram scale by combining components in the amounts indicated in Table 2 in a polypropylene MAX 100 DAC cup (FlackTek, Inc.). First, MMA, BHT, and CSP were combined and speed mixed with a DAC 400.2 VAC (FlackTek, Inc.) for 4 minutes at 2250 rpm, and then cooled in a freezer. This mixing was repeated three more times. Next, Starch and Silica were added, followed by mixing for 4 min at 2250 rpm and cooling in a freezer. This mixing was repeated. CHP was then added to the mixture and speed mixed at 1750 rpm for 4 min, followed by cooling in a freezer for 5 minutes. The final adhesive resin mixture was then degassed by capping the mixing cup with a polypropylene lid that contained a vent hole, and high shear mixed under reduced pressure 0.68 psi (~35 Torr) for 2 minutes.

TABLE 2
Part A Examples (Ex) and Illustrative Examples (IE) (Amounts in wt. %)

| Example | MMA | BHT | MEHQ | MBTBMP | BCP | NBR | CSP | Copolymer | Starch | Silica | CHP |
|---|---|---|---|---|---|---|---|---|---|---|---|
| Ex A-1 | 46.8 | 1.1 | 0 | 0 | 35.0 | 0 | 0 | 0 | 10.1 | 5.0 | 2.0 |
| IE A-2 | 57.2 | 1.0 | 0 | 0 | 0 | 0 | 0 | 24.5 | 10.2 | 5.0 | 1.9 |
| IE A-3 | 71.7 | 0 | 0 | 0.94 | 0 | 14.7 | 10.8 | 0 | 0 | 0 | 1.9 |
| IE A-4 | 71.4 | 0 | 0.7 | 0 | 0 | 15.0 | 11.0 | 0 | 0 | 0 | 1.9 |
| IE A-5 | 67.8 | 1.1 | 0 | 0 | 0 | 9.0 | 5.0 | 0 | 10.0 | 5.0 | 2.0 |
| IE A-6 | 66.8 | 1.1 | 0 | 0 | 0 | 15.0 | 0 | 0 | 10.0 | 5.0 | 2.0 |
| IE A-7 | 66.8 | 1.1 | 0 | 0 | 0 | 0 | 15.0 | 0 | 10.0 | 5.0 | 2.0 |

The Accelerated Shelf-Life Test was carried out on Ex A-1 and IE A-2 to A-7. The results are shown in Table 3, below.

TABLE 3
Accelerated Shelf-Life Test Results on Ex A-1
and IE A-2 to A-7 at 120 °F (49 °C)

| Example | Gel time at 120 °F (49 °C) | |
|---|---|---|
| Ex A-1 | >6.5 | months |
| IE A-2 | 3 | weeks |
| IE A-3 | 4 | weeks |
| IE A-4 | 3 | weeks |
| IE A-5 | 1 | week |
| IE A-6 | 1 | week |
| IE A-7 | 1.4 | weeks |

### PART B EXAMPLES

### Illustrative Example B-1 and Examples B-2 Through B-5 and B-7 Through B-9

Illustrative Example B-1 and Examples B-2 through B-5 and B-7 through B-9 were prepared by combining components in the amounts indicated in Table 4 in a polypropylene MAX 60 or 100 DAC cup (FlackTek, Inc.). First, MMA, MAA, XL, Phosphate, BHT, and VaAcAc were combined, and speed mixed with a DAC 400.2 VAC (FlackTek, Inc.) for 4 minutes at 2250 rpm, whereupon the VaAcAc completely dissolved. NBR was then added next, and the mixture was speed mixed for 4 minutes at 2250 rpm, followed by mixing again for 4 min at 2250 rpm. The CSP was then added to the speed mixer cup, and the mixture was speed mixed for 4 minutes at 2250 rpm, followed by cooling in a freezer for 5 minutes. This was repeated three more times. Next, the Wax, CB, and GS were added, and the mixture was speed mixed at 2250 rpm for 4 min, followed by cooling in a freezer for 5 minutes. The final adhesive resin mixture was then degassed by capping the mixing cup with a polypropylene lid that contained a vent hole, and high shear mixed under reduced pressure 0.68 psi (~35 Torr) for 2 minutes. The part A and part B materials were then separately loaded into each side of a 1:1 dual syringe cartridge dispenser.

### Example B-6

Example B-6 was prepared at a 5000-gram scale by combining components in the amounts indicated in Table 4 in the same mixer described above for Example A-1. First, MMA, MAA, XL, Phosphate, BHT, and VaAcAc were added to the mixer, and mixing was begun with the anchor blades set at 54 rpm and the disperser blades set at 3267 rpm. After about 30 minutes of mixing the kettle, temperature was at 114 °F (46 °C). NBR was then added, and mixing was continued with the same mixer setting for 24 minutes. Next, CSP was added, and mixing was continued for 45 minutes. The kettle temperature was at 110 °F (43 °C). Next, Wax, CB, and GS were added, and mixing was continued with the anchor blade at 54 rpm and the disperser blade at 3850 rpm. Mixing was continued for 20 minutes. The kettle temperature was at 111 °F (44 °C). Finally, the material was degassed while mixing was continued, and the vacuum reached about −22 to −23 inches (559-584 mm) of Hg. After degassing, the material was emptied. The part A and part B materials were then separately loaded into each side of a 1:1 dual syringe cartridge dispenser.

TABLE 4
Part B Examples (Ex) and Illustrative Example (IE) (Amounts in wt. %)

| Ex. | MMA | MAA | XL | Phosphate | BHT | VaAcAc | NBR | CSP | Wax | CB | GS |
|---|---|---|---|---|---|---|---|---|---|---|---|
| IE B-1 | 39.6 | 9.7 | 20.0 | 0.0 | 0.15 | 0.75 | 15.0 | 11.3 | 2.2 | 0.3 | 1.0 |
| Ex B-2 | 38.6 | 9.7 | 20.0 | 1.0 | 0.15 | 0.75 | 15.0 | 11.3 | 2.2 | 0.3 | 1.0 |
| Ex B-3 | 38.1 | 9.7 | 20.0 | 1.5 | 0.15 | 0.75 | 15.0 | 11.3 | 2.2 | 0.3 | 1.0 |
| Ex B-4 | 37.8 | 9.7 | 20.0 | 1.85 | 0.15 | 0.75 | 15.0 | 11.3 | 2.2 | 0.3 | 1.0 |
| Ex B-5 | 37.8 | 9.7 | 20.0 | 1.9 | 0.15 | 0.75 | 15.0 | 11.3 | 2.2 | 0.3 | 1.0 |
| Ex B-6 | 37.6 | 9.7 | 20.0 | 2.0 | 0.15 | 0.75 | 15.0 | 11.3 | 2.2 | 0.3 | 1.0 |
| Ex B-7 | 37.5 | 9.7 | 20.0 | 2.1 | 0.15 | 0.75 | 15.0 | 11.3 | 2.2 | 0.3 | 1.0 |
| Ex B-8 | 37.3 | 9.7 | 20.0 | 2.3 | 0.15 | 0.75 | 15.0 | 11.3 | 2.2 | 0.3 | 1.0 |
| Ex B-9 | 37.1 | 9.7 | 20.0 | 2.5 | 0.15 | 0.75 | 15.0 | 11.3 | 2.2 | 0.3 | 1.0 |

### MIXED PART A AND PART B EXAMPLES

### Illustrative Example (IE) M-1 and Examples (Ex) M-2 to M-9

For IE M-1 and Ex M-2 through M-9, Example A-1 and the Part B indicated below were mixed in a 1:1 ratio. The Overlap Shear (OLS) Test was performed on 1) abraded aluminum, 2) MEK wiped aluminum, 3) chemically etched aluminum, 4) Green FRP, and 5) Red FRP using the test method described above. Also, the Side Impact Test (SI) and the Bell Peel Strength Test (BPS) were performed, and the results are presented in Table 5. The Rheology Test (Storage Modulus vs. Time) was carried out on IE M-1 and Ex M-2 to M-4, M-6, M-8, and M-9, and the results are shown in FIG. 1.

TABLE 5
Results for IE M-1 and Examples M-2 to M-9

| | | OLS | OLS | OLS | OLS | OLS | | BPS |
|---|---|---|---|---|---|---|---|---|
| Ex- | | 1 | 2 | 3 | 4 | 5 | SI | (lb_{f}/ |
| ample | Part B | (psi) | (psi) | (psi) | (psi) | (psi) | (J) | in) |
| IE M-1 | IE B-1 | 416 | 857 | 798 | 1145 | 385 | 1.2 | 9.0 |
| Ex M-2 | Ex B-2 | 222 | 453 | 399 | 595 | 391 | 1.4 | 3.2 |
| Ex M-3 | Ex B-3 | 536 | 510 | 386 | 732 | 514 | 3.6 | 3.6 |
| Ex M-4 | Ex B-4 | 1265 | 1591 | 1642 | 2120 | 757 | 7.4 | 24.1 |
| Ex M-5 | Ex B-5 | 2145 | 2203 | 2342 | 2182 | 793 | 7.6 | 16.7 |
| Ex M-6 | Ex B-6 | 2900 | 2655 | 3031 | 2504 | 771 | 16.5 | 37.5 |
| Ex M-7 | Ex B-7 | 2174 | 2229 | 2351 | 2288 | 851 | 17.3 | 44.2 |
| Ex M-8 | Ex B-8 | 2677 | 2648 | 2665 | 2409 | 802 | 20.1 | 41.2 |
| Ex M-9 | Ex B-9 | 2043 | 1843 | 1868 | 1963 | 723 | 19.1 | 46.8 |

The Cataplasm Test and DMA were performed on Ex M-6. Ex M-6 had 90% retention after the Cataplasm Test and a glass transition temperature of 143 °C. Open Time was evaluated for Ex M-6 using the Open Time Test described above and found to be between 15 and 20 minutes. The results are shown in Table 6, below.

TABLE 6
Open Time Evaluation for Example M-6

| Time | | OLS - Abraded Aluminum (psi) | % Relative to t = 0 control |
|---|---|---|---|
| 0 | min | 2900 | |
| 15 | min | 2325 | 80% |
| 20 | min | 2215 | 76% |
| 25 | min | 2155 | 74% |
| 30 | min | 2231 | 77% |

The preceding description, given in order to enable one of ordinary skill in the art to practice the claimed disclosure, is not to be construed as limiting the scope of the disclosure, which is defined by the claims and all equivalents thereto.

1. A two-part adhesive composition comprising:
a first part comprising:
methyl methacrylate;
a block copolymer of methyl methacrylate and at least one of a C₄-C₉ alkyl acrylate or methacrylate or a C₂₋₄ hydroxyalkyl acrylate or methacrylate;
a free-radical initiator comprising at least one of a peroxide initiator or a hydroperoxide initiator; and
a free-radical inhibitor, and
a second part comprising:
methyl methacrylate;
a crosslinker having two or more acrylate groups, methacrylate groups, or a combination thereof;
an acrylic monomer comprising at least one of a phosphate or phosphonate group; and
vanadyl acetylacetonate.

2. The two-part adhesive composition of claim 1, wherein the first part further comprises starch.

3. The two-part adhesive composition of claim 1, wherein the two-part adhesive composition is free of acid chloride or comprises not more than 0.05 weight percent of an acid chloride, based on the total weight of the two-part adhesive composition.

4. The two-part adhesive composition of claim 1, wherein the free-radical initiator is the hydroperoxide initiator, and wherein the hydroperoxide initiator is cumene hydroperoxide.

5. The two-part adhesive composition of claim 1, wherein the free-radical initiator is present in an amount from 0.5 weight percent to 3.5 weight percent, based on the total weight of the first part, and wherein the free-radical inhibitor is present in an amount that is at least half of the amount by weight of the free-radical initiator.

6. The two-part adhesive composition of claim 1, wherein the block copolymer is a poly(methyl methacrylate)-poly(n-butyl (meth)acrylate)-poly(methyl methacrylate) triblock copolymer.

7. The two-part adhesive composition of claim 1, wherein the acrylic monomer comprising at least one of a phosphate or phosphonate group is present in an amount in a range from 1.85 weight percent to 3 weight percent, based on the total weight of the second part.

8. The two-part adhesive composition of claim 1, wherein the second part further comprises an elastomer.

9. The two-part adhesive composition of claim 1, wherein the second part further comprises at least one of acrylic acid or methacrylic acid.

10. The two-part adhesive composition of claim 1, wherein the second part is essentially free of thioureas, amines, and other metal salt reducing agents.

11. The two-part adhesive composition of claim 1, wherein the second part comprises monomers consisting of the methyl methacrylate; the crosslinker having two or more acrylate groups, methacrylate groups, or a combination thereof; the acrylic monomer comprising at least one of a phosphate or phosphonate group; and methacrylic acid.

12. The two-part adhesive composition of claim 1, wherein the crosslinker having two or more acrylate groups, methacrylate groups, or a combination thereof is a non-cyclic crosslinker.

13. A method of making a bonded article comprising a first substrate and a second substrate, the method comprising:
combining the first part and the second part of the two-part adhesive composition of claim 1 to provide an adhesive;
applying the adhesive to at least one of the first substrate or the second substrate;
adhering the first substrate and the second substrate using the adhesive; and
allowing the adhesive to at least partially cure to make the bonded article.

14. The method of claim 13, wherein the first part and the second part are combined in a volume ratio in a range from 1.5:1 to 1:1.5.

15. A first part of a two-part adhesive composition, the first part comprising:
methyl methacrylate;
a block copolymer of methyl methacrylate and at least one of a C₄-C₉ alkyl acrylate or methacrylate or a C₂₋₄ hydroxyalkyl acrylate or methacrylate;
a free-radical initiator comprising at least one of a peroxide initiator or a hydroperoxide initiator;
a free-radical inhibitor; and
starch.

16. The first part of the two-part adhesive composition of claim 15, wherein the starch is corn starch.

17. The first part of the two-part adhesive composition of claim 15, wherein the block copolymer is a poly(methyl methacrylate)-poly(n-butyl (meth)acrylate)-poly(methyl methacrylate) triblock copolymer.

18. The first part of the two-part adhesive composition of claim 15, wherein the free-radical initiator is the hydroperoxide initiator, and wherein the hydroperoxide initiator is cumene hydroperoxide.

19. The first part of the two-part adhesive composition of claim 15, wherein the first part comprises 25 weight percent to 65 weight percent methyl methacrylate, based on the total weight of the first part of the two-part adhesive composition.

20. The first part of the two-part adhesive composition of claim 15, wherein the free-radical inhibitor is present in an amount that is at least half of the amount by weight of the free-radical initiator.
